(19) United States
(12) Patent Application Publication
(10) Pub. No.: US 2026/0118472 A1
(43) Pub. Date: Apr. 30, 2026

(54) OBSERVER-BASED MEASUREMENTS FOR INCREASED COMMUNICATION RANGING ACCURACY

(71) Applicant: Cisco Technology, Inc., San Jose, CA (US)

(72) Inventors: Jerome HENRY, Pittsboro, NC (US); Laurent Alexandre PIERRUGUES, San Jose, CA (US); Behrouz SHAYESTEH, Campbell, CA (US)

(21) Appl. No.: 18/926,387

(22) Filed: Oct. 25, 2024

(51) Int. Cl. G01S 5/02; H04W 64/00

(52) U.S. Cl. CPC G01S 5/0284; H04W 64/003

(57) ABSTRACT

In one embodiment, a method may comprise: enabling, in response to a wireless ranging communication between a first and second device to determine a distance between the first and second device, a listening mode on an observer device in proximity to both the first and second device to observe the wireless ranging communication between the first and second device; deducing, based on observation of the wireless ranging communication between the first and second device, a first complimentary measurement between the observer device and the first device, and a second complimentary measurement between the observer device and the second device; and using the distance between the first and second device, the first complimentary measurement between the observer device and the first device, and the second complimentary measurement between the observer device and the second device for a relational location computation amongst the first device, the second device, and the observer device.

### TECHNICAL FIELD

The present disclosure relates generally to computer networks, and, more particularly, to observer-based measurements for increased communication ranging accuracy.

### BACKGROUND

When a Wi-Fi network is deployed, fine timing measurement (FTM) is used to assess access point (AP)-to-AP distances and build a graph of the AP locations. The process is time consuming, because many pairs are in complex non-line of sight (nLoS) scenarios (e.g., obstacles causing inaccuracies in the samples measurements, asymmetries within a pair, canyons causing unpredictable distance stretches, etc.).

Ranging to help build the network graph is just one activity of the deployed access points, whose primary role is to provide Wi-Fi coverage to the wireless client devices (“STAs”). Thus, it is imperative to limit the amount of effort and airtime consumption spent on AP-to-AP location computations. At the same time, however, there is also a need to expedite measurements in order to provide a complete graph as soon as possible.

### BRIEF DESCRIPTION OF THE DRA WINGS

The embodiments herein may be better understood by referring to the following description in conjunction with the accompanying drawings in which like reference numerals indicate identically or functionally similar elements, of which:

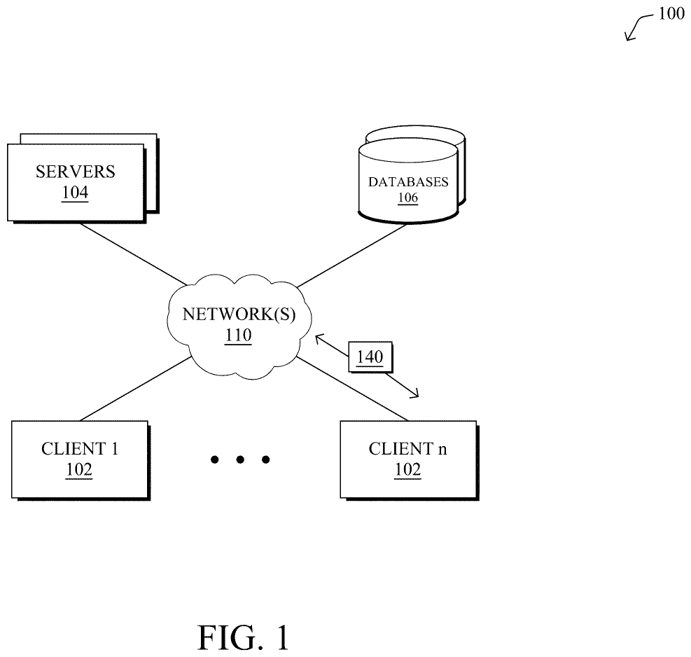

FIG. 1 illustrates an example computing system;

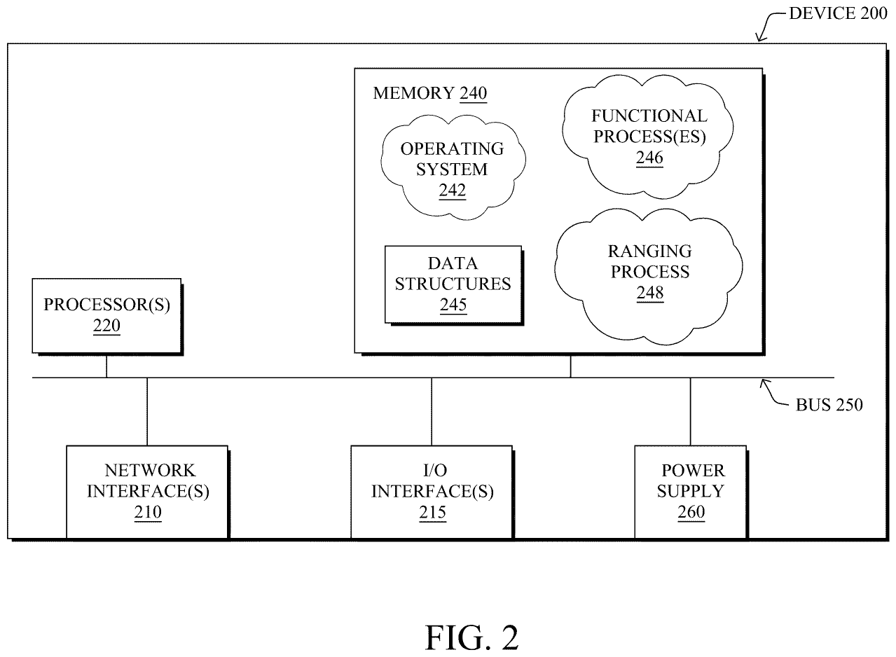

FIG. 2 illustrates an example network device/node;

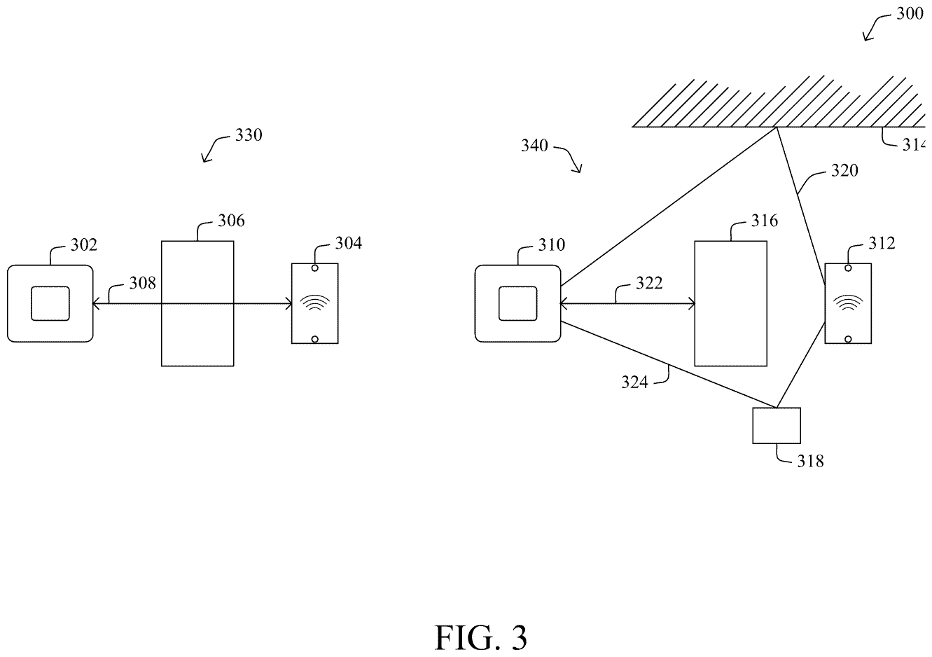

FIG. 3 illustrates an example of various scenarios of fine timing measurement (FTM)-based ranging;

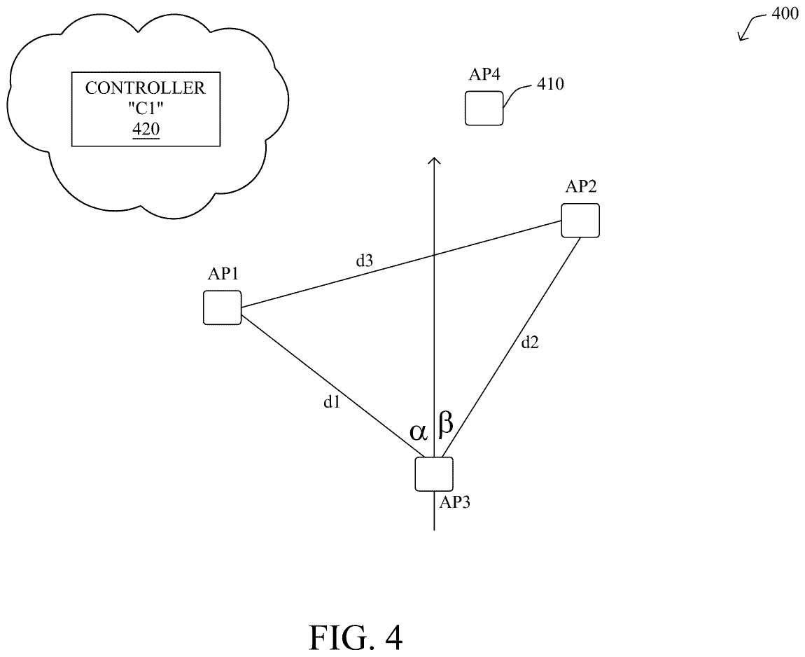

FIG. 4 illustrates an example of observer-based measurements for increased communication ranging accuracy;

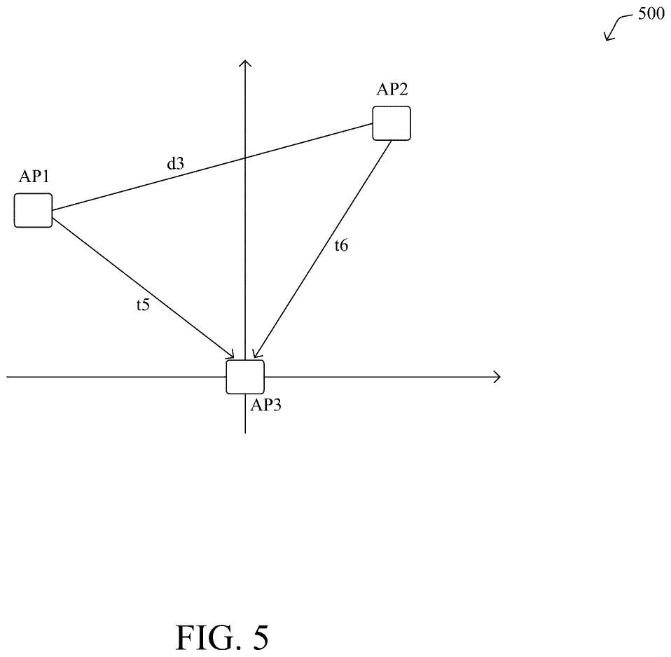

FIG. 5 illustrates another example of observer-based measurements for increased communication ranging accuracy;

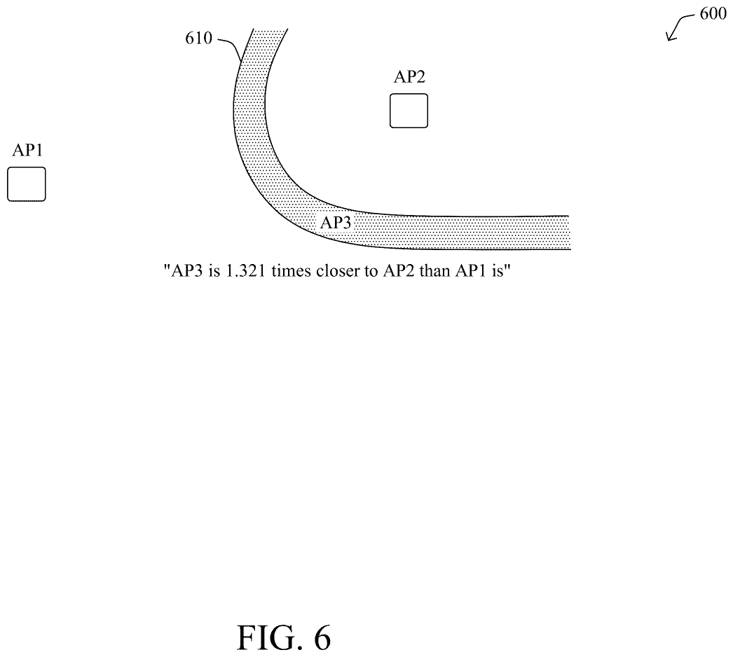

FIG. 6 illustrates still another example of a hyperbolic proximity estimation;

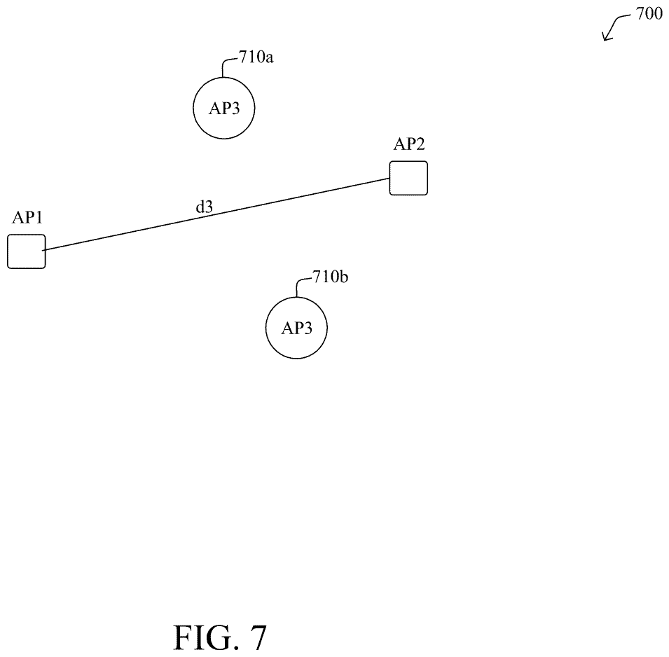

FIG. 7 illustrates still another example of limited proximity estimation; and

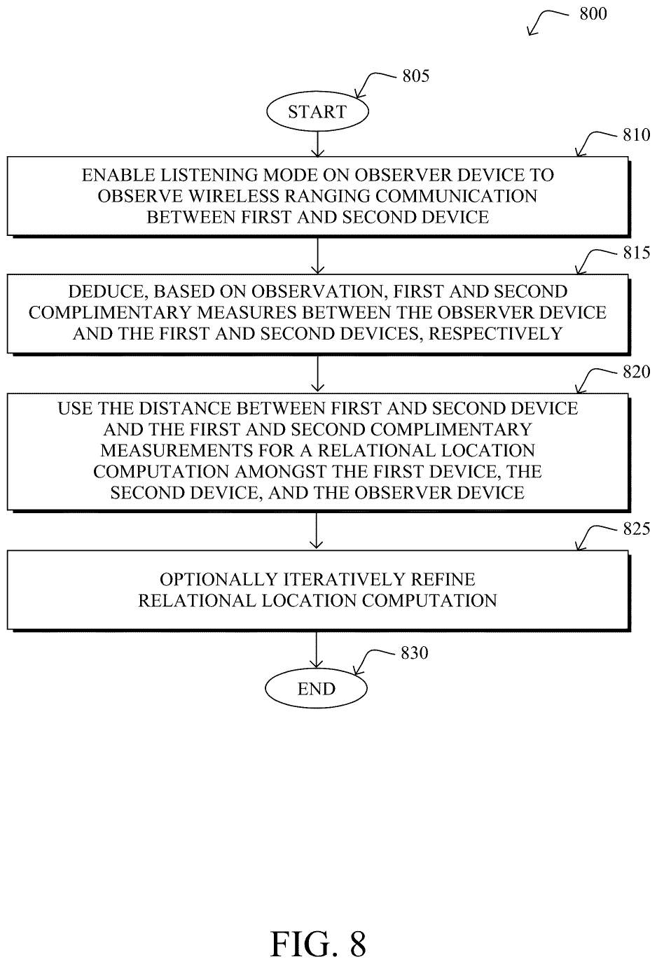

FIG. 8 illustrates an example procedure for observer-based measurements for increased communication ranging accuracy.

### DESCRIPTION OF EXAMPLE EMBODIMENTS

### Overview

According to one or more embodiments of the disclosure, observer-based measurements for increased communication ranging accuracy is provided herein. In one embodiment, an illustrative method may comprise: enabling, by a process and in response to a wireless ranging communication between a first device and a second device to determine a distance between the first device and the second device, a listening mode on an observer device in proximity to both the first device and the second device to observe the wireless ranging communication between the first device and the second device; deducing, by the process and based on observation of the wireless ranging communication between the first device and the second device, a first complimentary measurement between the observer device and the first device, and a second complimentary measurement between the observer device and the second device; and using, by the process, the distance between the first device and the second device, the first complimentary measurement between the observer device and the first device, and the second complimentary measurement between the observer device and the second device for a relational location computation amongst the first device, the second device, and the observer device.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to route to a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a ranging process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### ——Observer-Based Measurements for Increased Ranging Accuracy——

Wireless networks have become an integral part of modern communication systems, providing connectivity for a wide range of devices. One of the aspects of these networks is the ability to accurately determine the location of devices within the network. This is particularly important in indoor environments where global navigation satellite (GNSS)-based location services may not be effective.

As noted above, fine timing measurement (FTM) is used to assess access point (AP)-to-AP distances and build a graph of the AP locations. FTM, in general, is a technique that has been increasingly used for indoor location determination, especially in scenarios involving access point to access point (AP-to-AP) and client device (e.g., a station, a STA) to access point cases.

However, FTM-based location determination faces challenges in non-line-of-sight (nLOS) scenarios. In such situations, strong reflections, often referred to as “canyons,” can cause inaccurate ranging results. This is because the signal may reach the receiver after a path longer than a straight line due to reflections, or reflected artifacts may cause a lobe to reach the receiver at the wrong time, resulting in a computed distance that is shorter than the actual straight-line distance. The problem is further exacerbated in AP-to-AP ranging scenarios. This is because the design of the APs, their placement, and the physical obstacles in the environment can significantly degrade the signal quality, especially when measurements are lateral, e.g., through the AP body. As a result, there can be scenarios where AP-to-AP ranging works optimally, but many other scenarios where AP-to-AP ranging provides inaccurate results.

In more detail, FTM-based ranging may be a technique used in wireless networks where an initiating device (e.g., an initiating station (ISTA) for ranging) sends an FTM request frame to a responding device (e.g., a responding station (RSTA) for ranging), and the distance between the two devices can be calculated based on the round-trip time of the FTM response frame received back at the initiating device.

In a number of embodiments, the network devices (e.g., APs) may have multiple radios on different channels. Multiple radios (receive/transmit chains) can operate on a given channel. By way of non-limiting examples, a network device may have 2, 3, 4, 5 . . . transmit chains and 2, 3, 4, 5, . . . receive chains. In a variety of embodiments, a pair of ranging network devices can each set one of their radios to a common channel.

Referring to FIG. 3, a diagram 300 illustrating various scenarios of FTM-based ranging in accordance with various embodiments of the disclosure is shown. In many embodiments, embodiment depicted in FIG. 3 may include a diagram 330 that shows an FTM-LOS scenario. In particular, as shown, an obstacle 306 can be situated between a responding device 302 and an initiating device 304. Despite the presence of the obstacle 306, a direct signal path 308 (e.g., an LOS path or a path very close to an LOS path) can still be established between the responding device 302 and the initiating device 304. The scenario shown in embodiments depicted in the diagram 330 can be identified as FTM-LOS, where obstacles may exist but do not create reflections or canyon effects that can distort the obtained range measurement. The obstacle 306, such as, but not limited to, a wall, may influence the RSSI, but it may not significantly impact the FTM-based range measurement.

In a number of embodiments, embodiment depicted in FIG. 3 may include a diagram 340 that illustrates an nLOS scenario. In particular, as shown, a reflective surface 314, such as, but not limited to, a wall or a ceiling, an obstacle 316, and a reflective obstacle 318 may be present in the environment surrounding a responding device 310 and an initiating device 312. The obstacle 316 can obstruct the straight line signal path 322 between the responding device 310 and the initiating device 312. The presence of the reflective surface 314 may create a reflected, non-straight line signal path 320 between the responding device 310 and the initiating device 312. Additionally, the reflective obstacle 318 can create another reflected signal path 324 between the responding device 310 and the initiating device 312. In nLOS conditions, such as the one shown in the embodiments depicted in the diagram 340, reflections (canyons), especially stronger ones, may cause wrong ranging results. In some cases, strict canyons can cause the signal to be reflected and the main lobe to reach the receiver after a path longer than a straight line. In other cases, reflected artifacts may cause a lobe to reach the receiver at the wrong time, causing the computed distance to be shorter than a straight line distance. In other words, the reflection pattern on obstacles in the environment may cause the initiating device to receive a reflected component as the primary signal. The reflection pattern can be influenced by the obstacles in the environment, and the frequency and bandwidth of the signal. Consequently, the range measurement obtained through reflected paths may not be the same when performed on different bands.

There are many reasons why FTM or other ranging calculations can be inaccurate or incorrect, whether based on objects, surfaces, materials, radio characteristics, or otherwise. Those shown above in FIG. 3 are merely meant to illustrate example situations of LOS and nLOS ranging communications between wireless devices. Also, although a specific embodiment for scenarios of FTM-based ranging suitable for carrying out the various steps, processes, methods, and operations described herein is discussed with respect to FIG. 3, any of a variety of systems and/or processes may be utilized in accordance with embodiments of the disclosure. For example, the initiating and responding devices may be equipped with multiple radios operating on different channels and bandwidths. Also, other techniques such as timed distance of arrival (TDOA) may be used for ranging communication and calculations herein, as will be appreciated by those skilled in the art.

As also noted above, ranging to help build the network graph is just one activity of the deployed access points, whose primary role is to provide Wi-Fi coverage to the wireless client devices (STAs). Thus, it is imperative to limit the amount of effort and airtime consumption spent on AP-to-AP location computations. At the same time, however, there is also a need to expedite measurements in order to provide a complete graph as soon as possible.

Moreover, once the graph is built and the network operational, measurements between APs need to continue, as it is common that APs would be moved, or added/removed. Here again, the time-to-update has to be minimized, while still minimizing the exchanges needed to obtain enough data to build the graph.

The techniques herein, therefore, provide for observer-based measurements for increased communication ranging accuracy. In particular, the techniques herein augment ranging accuracy by leveraging the notion of a channel state information (CSI) observer, where a third AP (that may also need to range against other APs) first observes the dialog (e.g., an FTM dialog) between two other APs, to 1) deduce the optimal ranging parameters based on its analysis of the real time channel conditions, and 2) augment the ranging accuracy by using geometric methods to refine the location calculations of the three APs' relative distances and/or angles.

Specifically, according to one or more embodiments of the disclosure as described in detail below, an example method herein may comprise: enabling, by a process and in response to a wireless ranging communication between a first device and a second device to determine a distance between the first device and the second device, a listening mode on an observer device in proximity to both the first device and the second device to observe the wireless ranging communication between the first device and the second device; deducing, by the process and based on observation of the wireless ranging communication between the first device and the second device, a first complimentary measurement between the observer device and the first device, and a second complimentary measurement between the observer device and the second device; and using, by the process, the distance between the first device and the second device, the first complimentary measurement between the observer device and the first device, and the second complimentary measurement between the observer device and the second device for a relational location computation amongst the first device, the second device, and the observer device.

FIG. 4 illustrates an example simplified wireless communication environment, environment 400, comprising a number of access points (APs 410), such as “AP1”, “AP2”, and “AP3”, as shown. In certain embodiments, additional APs, such as “AP4” may also be utilized. In one embodiment, a controller 420 (“C1”), such as a wireless LAN controller (WLC), may also be in communication with the APs, such as over a local network connection (e.g., an on-prem controller) or over an Internet connection to a remote location (e.g., a cloud-based controller).

Operationally, the techniques herein present a method to minimize the exchange between AP pairs when performing ranging/FTM exchanges, while maximizing the amount of data collected to determine the range.

Consider the system of at least three APs deployed on a floor, such as shown in FIG. 4, and that they need to range with one another. In general, after initial deployment, each AP starts discovering other APs and their associated channels, as will be appreciated by those skilled in the art (e.g., neighbor discovery protocol, NDP, etc.).

According to the techniques herein, a first AP (e.g., AP1) starts a ranging communication session to a second AP (e.g., AP2) as part of a location service, whether for locating AP1, locating AP2, or generally determining a distance (in terms of time, physical distance, signal strength or other characteristics) between AP1 and AP2. In one embodiment herein, AP1 acts as the initiator (e.g., an initiator STA or “ISTA”) by sending an initiating FTM (iFTM) request to AP2, and upon receiving the iFTM message, AP2 sends a message to AP3, asking it to enter an observer mode (or “listening mode”). In another embodiment, AP1, at the time of sending the iFTM message, also sends the message to AP3 asking it to be an observer. In still another embodiment, a centralized controller (e.g., C1) or other positioning platform choreographing the ranging process may initiate the ranging communication session and may assign the observer role to AP3, either initiating the session or instructing AP1/AP2 to notify AP3 of its requested status.

Since AP1 and AP2 may operate on different channels (e.g., AP1 on channel “1” and AP2 on channel “2”) during the ranging communication session, AP3 may be configured to set its radio (e.g., one of its radios, such as a secondary radio, a dedicated monitor radio, or a primary radio if non-intrusive to standard operation) to the common channel between AP1 and AP2 at the time of the ranging communication. That is, the instruction to become an observer device herein may include an indication and/or implication on when to switch to a particular “listening” channel at a particular time/cadence to observe the ranging communications between AP1 and AP2 (e.g., “in 200 ms, AP1 will go to channel “1” to perform an FTM to AP2”).

AP1 and AP2 then proceed to the ranging/FTM exchange, e.g., in a conventional manner. That is, AP1 may send an FTM message at time t1, received at time t2 by AP2, that responds with an ACK frame sent at time t3, that reaches AP1 at time t4. In a subsequent message, AP1 sends the {t1, t4} timers to AP2, as will be appreciated by those skilled in the art.

As the exchange occurs, AP3 observes the ranging communication (e.g., FTM frames). In one embodiment herein, AP3 uses the frames' channel state information (CSI) to evaluate the channel between AP3 and AP1, and between AP3 and AP2. AP3 may then use this information to select the best channel parameters (channel width, best likely transmit/receive (Tx/Rx) chain and, based on the channel stability, a best likely burst count, duration and intervals, and so on) for its own ranging/FTM exchanges with AP1 and AP2, thus optimizing the parameters based on real time channel conditions without the need for specific channel sounding.

In another embodiment, AP3 uses the frame CSI to establish angle of arrival (AoA) information for the messages coming from AP1 and the messages coming from AP2. This result provides AP3 with an evaluation (albeit a potentially noisy evaluation) of its angle (alpha) with AP1, and its angle (beta) with AP2. Note that collecting the CSI of the FTM exchange can provide important information about the channel, including channel stability, used to determine the line-of-sight (LoS) versus non-LOS (nLoS) scenarios. CSI can also be used to infer an AoA, which can be used to add angular information to the distance graph, and refine the graph accuracy.

AP3 also hears the timers exchanged between AP1 and AP2, and thus also obtains the same noisy distance measurement d3 between AP1 and AP2 as the other two APs. In one embodiment, AP2 sends {t2,t3} in a location measurement report (LMR) feedback, and AP1, just like AP2 and now AP3, have all 4 timers {t1, t2, t3, t4}. In another embodiment, d3 or the timers are sent by AP2 to AP3 over the air or over the distribution system, or “over-the-DS”. Next, AP3 performs FTM ranging with AP1 and AP2 in turn, as above, and obtains noisy distance measurements d1 and d2.

Now, according to certain aspects of the embodiments herein, AP3 (the observer device) can use geometric principles to minimize the errors in the measurements obtained, noting for example that:

$$cos ( α + β ) = \frac{{d}_{1}^{2} + {d}_{2}^{2} - {d}_{3}^{2}}{2 ( {d}_{1} ) ( {d}_{2} )} \qquad Eq . 1$$

Therefore, the standard distance minimization techniques (least squares and others) are now complemented with an angular technique. Both techniques in combination reduce the error and improve the resulting location accuracy. (And, notably, when the angles of the three APs produce a 180-degree triangle, it can be assumed that the solution is correct. Or, more poignantly, if the angles of the three APs do not produce a 180-degree triangle, it can be determined that the solution is incorrect.)

In another embodiment, as illustrated with reference to example 500 of FIG. 5, AP3 receives the FTM frames from AP1 and AP2, and observes their respective time of arrival. The FTM frames from AP1 (sent at t1) reach AP3 at time t5, and the ACK from AP2 (sent at t3 and reaching AP1 at t4) reach AP3 at t6.

By comparing (t6-t5) to (t4-t1) reported by AP1, AP3 now knows how much closer (or farther) it is to AP2 than AP1. This “relative closeness”, as shown in example 600 of FIG. 6 (e.g., “AP3 is 65423/49525 (=1.321) times closer to AP2 than AP1 is”), results in a hyperbolic proximity estimation 610 for AP3.

As d3 is estimated, AP3's position becomes constrained to two possible positions, as shown in the example 700 of FIG. 7 (positions 710a and 720b). Notably, the error/noise in the d3 estimation may be smaller or larger than the hyperbolic proximity for AP3.

In one embodiment, as the ranging/FTM process can be configured to iterate (repeat) between AP2 and AP3, and between AP3 and AP1, the same hyperbolic estimation may be made for AP1 and AP2 positions, respectively.

According to the techniques herein, the location process/engine may complement the FTM error minimization techniques with the added constraints of the hyperbolic position estimations, thus increasing the accuracy of the resulting position estimation.

In still another embodiment, the geometric method above may be added to the hyperbolic method, both contributing to reduce the FTM measurement error.

In a further embodiment, additional observers (e.g., AP4) may be used to further converge on the relative locations of the devices.

In closing, FIG. 8 illustrates an example simplified procedure for observer-based measurements for increased communication ranging accuracy in accordance with one or more embodiments described herein, particularly from the perspective of an observer device and/or controller, as described above. For example, a non-generic, specifically configured device (e.g., device 200, an apparatus) may perform procedure 800 by executing stored instructions (e.g., process 248). The procedure 800 may start at step 805, such as in response to a wireless ranging communication (e.g., an FTM communication) between a first device and a second device (e.g., access points, such as AP1 and AP2 above, or other wirelessly enabled devices, generally stationary though optionally mobile) to determine a distance between the first and second device. As described above, step 805 may be based on a request received from the second device responsive to the wireless ranging communication (e.g., after receiving a ranging request from the first device), or may be based on a request from a controller device (e.g., C1 above) that initiates the wireless ranging communication.

The procedure continues to step 810, where, as described in greater detail above, the techniques herein enable a listening mode on an observer device (e.g., another wireless access point, such as AP3) in proximity to both the first and second device to observe the wireless ranging communication between the first and second device. As mentioned above, the observer device may observe the wireless ranging communication by listening on a first communication channel for first ranging communications from the first device and listening on a second communication channel for second ranging communications from the second device.

In step 815, the techniques herein may then deduce, based on observation of the wireless ranging communication between the first and second device, a first complimentary measurement between the observer device and the first device, and a second complimentary measurement between the observer device and the second device (e.g., in one embodiment, based in part on channel state information (CSI) of the wireless ranging communication between the first and second devices).

In particular, as defined herein, a “complimentary measurement” between the observer device and the first and second devices generally implies any measurement made (e.g., by a third device) based on the indirect observation of ranging communication between the first and second devices as a compliment to the result of that ranging communication. For instance, in one embodiment herein, the first complimentary measurement may comprise a first angle of arrival from the observer device to the first device, and the second complimentary measurement may comprise a second angle of arrival from the observer device to the second device. In another embodiment, the first complimentary measurement may comprise a first time of travel (or timed distance of arrival, TDOA, or other timestamp-based ranging calculations) of the wireless ranging communication to reach the observer device from the first device, and the second complimentary measurement may comprise a second time of travel of the wireless ranging communication to reach the observer device from the second device.

Notably, as described above, these complimentary measurements (particularly time-based measurements) may also be used in step 815 to further determine a relative closeness of the observer device to the first device versus to the second device, to thus generate a hyperbolic proximity estimation of the observer device in relation to the first and second device for use within the relational location computation, below. (As also described above, the techniques herein may further limit the hyperbolic proximity estimation to two potential locations for the observer device relative to the first and second devices based on the distance between the first and second devices, accordingly.)

In step 820, the techniques herein may thus use the distance between the first and second devices, the first complimentary measurement between the observer device and the first device, and the second complimentary measurement between the observer device and the second device for a “relational location computation” amongst the first device, the second device, and the observer device. That is, as defined herein, a relational location computation is a location relative to one another, such as knowing distances relative to one another, angles relative to one another, and so on. When combined with a known location (e.g., assumed, configured, determined, etc.) of one of the devices, a relational location can then be used to pinpoint the location of another of the devices. For instance, if the GPS location of AP2 is known, then a physical location of AP1 could be computed based on its relative location to AP2 according to the techniques herein, refined based on the observations of AP3, accordingly.

When more information is used in the relational location computation, more accurate results can be obtained. For instance, when angles of arrival are used as the complimentary measurements from the observer device, the techniques herein may further range a first and second distance between the observer device and the first and second devices, respectively, to use these measurements within the relational location computation for further accuracy/refinement.

Moreover, as shown in step 825, the techniques herein may optionally iteratively refine the relational location computation. That is, additional computations may be made and/or additional measurements may be made in order to provide further accuracy/refinement. For instance, the observer role may be iterated through the first and second devices while the observer device ranges to each other device, confirming the measurements from each device's own perspectives and observations. That is, the techniques herein may refine the relational location computation based on the first device observing a second wireless ranging communication between the second device and the observer device, and based on the second device observing a third wireless ranging communication between the first device and the observer device. Additionally, the relational location computation may be refined based on a second observer device (or more) observing the wireless ranging communication between the first device and the second device.

In still another embodiment, refinement in step 825 may consist of performing multiple methods/types of measurement and associated calculations. For instance, if angles of arrival are first used, the location may be refined by then using the hyperbolic proximity estimation. Alternatively, if the hyperbolic proximity estimation is first used, then this may be further refined using angles of arrival. Said differently, the techniques herein may additionally deduce, based on the observation of the wireless ranging communication between the first device and the second device, a third and fourth complimentary measurement between the observer device and the first and second devices, where those additional measurements may be used within the relational location computation either along with the first and second complimentary measurements, or else used in a subsequent “refinement computation”.

Procedure 800 may illustratively end at step 830. Other steps described herein but not shown may also be included within the procedure 800, such as determining communication parameters for the observer device to communicate with each of the first device and the second device based on observations from the wireless ranging communication, among other steps described above.

That is, it should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

The techniques described herein, therefore, provide for observer-based measurements for increased communication ranging accuracy. In particular, while current ranging technologies such as FTM are reasonable, they are often limited in terms of their accuracy and also take an extended time to accomplish. The techniques herein augment the ranging/FTM between Access Points to improve the accuracy of AP location estimation, and to do so in a much shorter time (e.g., 1-2 hours as opposed to up to 24 hours in the current state of the art). As described above, observing the ranging/FTM exchanges and CSI between two APs by a third “observer” AP (e.g., on the same floor) enables an estimation of the distances between the APs (as well as saving a channel sounding by the observer AP for communications with the other APs). The observer role can rotate between the three APs for each ranging exchange between pairs of APs, where a geometric position method and a hyperbolic position method assists in refining the relational location calculation of the three APs.

While other accuracy augmentation methods can be based on CSI evaluation, these require support for CSI capture from the FTM frame, which is difficult to solve for current chipset architectures. The techniques herein, therefore, have a higher likelihood of implementation while these chipset difficulties are being solved, and beyond. Also, other current techniques that address the issue of ranging accuracy, such as 802.11az, typically present a passive FTM method that also uses the observation of two APs ranging against one another (e.g., in 802.11az, used by a STA to deduce its own location). However, the technique proposed by 802.11az is fairly brittle, whereas the hyperbolic method presented herein is more robust to noise and thus more efficient for location computations, accordingly.

Illustratively, the techniques described herein may be performed by hardware, software, and/or firmware, (e.g., an “apparatus”) such as in accordance with the ranging process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

In some implementations, an illustrative method herein may comprise: enabling, by a process and in response to a wireless ranging communication between a first device and a second device to determine a distance between the first device and the second device, a listening mode on an observer device in proximity to both the first device and the second device to observe the wireless ranging communication between the first device and the second device; deducing, by the process and based on observation of the wireless ranging communication between the first device and the second device, a first complimentary measurement between the observer device and the first device, and a second complimentary measurement between the observer device and the second device; and using, by the process, the distance between the first device and the second device, the first complimentary measurement between the observer device and the first device, and the second complimentary measurement between the observer device and the second device for a relational location computation amongst the first device, the second device, and the observer device.

In one embodiment, the first complimentary measurement comprises a first angle of arrival from the observer device to the first device, and the second complimentary measurement comprises a second angle of arrival from the observer device to the second device. In one embodiment, the method further comprises: ranging a first distance between the observer device and the first device; ranging a second distance between the observer device and the second device; and using the first distance between the observer device and the first device and the second distance between the observer device and the second device within the relational location computation.

In one embodiment, the method further comprises: determining, based on the first complimentary measurement and the second complimentary measurement, a relative closeness of the observer device to the first device versus to the second device; and generating, based on the relative closeness, a hyperbolic proximity estimation of the observer device in relation to the first device and the second device for use within the relational location computation. In one embodiment, the first complimentary measurement comprises a first time of travel of the wireless ranging communication to reach the observer device from the first device, and the second complimentary measurement comprises a second time of travel of the wireless ranging communication to reach the observer device from the second device. In one embodiment, the method further comprises: limiting the hyperbolic proximity estimation to two potential locations for the observer device relative to the first device and the second device based on the distance between the first device and the second device.

In one embodiment, the method further comprises: deducing, based on observation of the wireless ranging communication between the first device and the second device, a third complimentary measurement between the observer device and the first device, and a fourth complimentary measurement between the observer device and the second device; and using the third complimentary measurement and the fourth complimentary measurement within the relational location computation. In one embodiment, the method further comprises: using the first complimentary measurement and the second complimentary measurement within an initial computation of the relational location computation, wherein the first complimentary measurement and the second complimentary measurement comprise a first type of measurement; and using the third complimentary measurement and the fourth complimentary measurement within a refinement computation of the relational location computation, wherein the third complimentary measurement and the fourth complimentary measurement comprise a second type of measurement different from the first type of measurement.

In one embodiment, enabling is based on one of either a) a request from the second device responsive to the wireless ranging communication or b) a request from a controller device that initiated the wireless ranging communication.

In one embodiment, the first device, the second device, and the observer device are wireless access points.

In one embodiment, the observer device observes the wireless ranging communication by listening on a first communication channel for first ranging communications from the first device and listening on a second communication channel for second ranging communications from the second device.

In one embodiment, the method further comprises: determining communication parameters for the observer device to communicate with each of the first device and the second device based on observations from the wireless ranging communication.

In one embodiment, the wireless ranging communication comprises fine timing measurement (FTM) communication.

In one embodiment, deducing the first complimentary measurement and the second complimentary measurement is based in part on channel state information (CSI) of the wireless ranging communication between the first device and the second device.

In one embodiment, the method further comprises: refining the relational location computation based on the first device observing a second wireless ranging communication between the second device and the observer device, and based on the second device observing a third wireless ranging communication between the first device and the observer device.

In one embodiment, the method further comprises: refining the relational location computation based on a second observer device observing the wireless ranging communication between the first device and the second device.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: enabling, in response to a wireless ranging communication between a first device and a second device to determine a distance between the first device and the second device, a listening mode on an observer device in proximity to both the first device and the second device to observe the wireless ranging communication between the first device and the second device; deducing, based on observation of the wireless ranging communication between the first device and the second device, a first complimentary measurement between the observer device and the first device, and a second complimentary measurement between the observer device and the second device; and using the distance between the first device and the second device, the first complimentary measurement between the observer device and the first device, and the second complimentary measurement between the observer device and the second device for a relational location computation amongst the first device, the second device, and the observer device.

In still other implementations, a tangible, non-transitory, computer-readable medium storing program instructions that cause a device to execute a process comprising: enabling, in response to a wireless ranging communication between a first device and a second device to determine a distance between the first device and the second device, a listening mode on an observer device in proximity to both the first device and the second device to observe the wireless ranging communication between the first device and the second device; deducing, based on observation of the wireless ranging communication between the first device and the second device, a first complimentary measurement between the observer device and the first device, and a second complimentary measurement between the observer device and the second device; and using the distance between the first device and the second device, the first complimentary measurement between the observer device and the first device, and the second complimentary measurement between the observer device and the second device for a relational location computation amongst the first device, the second device, and the observer device.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
enabling, by a process and in response to a wireless ranging communication between a first device and a second device to determine a distance between the first device and the second device, a listening mode on an observer device in proximity to both the first device and the second device to observe the wireless ranging communication between the first device and the second device;
deducing, by the process and based on observation of the wireless ranging communication between the first device and the second device, a first complimentary measurement between the observer device and the first device, and a second complimentary measurement between the observer device and the second device; and
using, by the process, the distance between the first device and the second device, the first complimentary measurement between the observer device and the first device, and the second complimentary measurement between the observer device and the second device for a relational location computation amongst the first device, the second device, and the observer device.

2. The method of claim 1, wherein the first complimentary measurement comprises a first angle of arrival from the observer device to the first device, and the second complimentary measurement comprises a second angle of arrival from the observer device to the second device.

3. The method of claim 2, further comprising:
ranging a first distance between the observer device and the first device;
ranging a second distance between the observer device and the second device; and
using the first distance between the observer device and the first device and the second distance between the observer device and the second device within the relational location computation.

4. The method of claim 1, further comprising:
determining, based on the first complimentary measurement and the second complimentary measurement, a relative closeness of the observer device to the first device versus to the second device; and
generating, based on the relative closeness, a hyperbolic proximity estimation of the observer device in relation to the first device and the second device for use within the relational location computation.

5. The method of claim 4, wherein the first complimentary measurement comprises a first time of travel of the wireless ranging communication to reach the observer device from the first device, and the second complimentary measurement comprises a second time of travel of the wireless ranging communication to reach the observer device from the second device.

6. The method of claim 4, further comprising:
limiting the hyperbolic proximity estimation to two potential locations for the observer device relative to the first device and the second device based on the distance between the first device and the second device.

7. The method of claim 1, further comprising:
deducing, based on observation of the wireless ranging communication between the first device and the second device, a third complimentary measurement between the observer device and the first device, and a fourth complimentary measurement between the observer device and the second device; and
using the third complimentary measurement and the fourth complimentary measurement within the relational location computation.

8. The method of claim 7, further comprising:
using the first complimentary measurement and the second complimentary measurement within an initial computation of the relational location computation, wherein the first complimentary measurement and the second complimentary measurement comprise a first type of measurement; and
using the third complimentary measurement and the fourth complimentary measurement within a refinement computation of the relational location computation, wherein the third complimentary measurement and the fourth complimentary measurement comprise a second type of measurement different from the first type of measurement.

9. The method of claim 1, wherein enabling is based on one of either a) a request from the second device responsive to the wireless ranging communication or b) a request from a controller device that initiated the wireless ranging communication.

10. The method of claim 1, wherein the first device, the second device, and the observer device are wireless access points.

11. The method of claim 1, wherein the observer device observes the wireless ranging communication by listening on a first communication channel for first ranging communications from the first device and listening on a second communication channel for second ranging communications from the second device.

12. The method of claim 1, further comprising:
determining communication parameters for the observer device to communicate with each of the first device and the second device based on observations from the wireless ranging communication.

13. The method of claim 1, wherein the wireless ranging communication comprises fine timing measurement (FTM) communication.

14. The method of claim 1, wherein deducing the first complimentary measurement and the second complimentary measurement is based in part on channel state information (CSI) of the wireless ranging communication between the first device and the second device.

15. The method of claim 1, further comprising:
refining the relational location computation based on the first device observing a second wireless ranging communication between the second device and the observer device, and based on the second device observing a third wireless ranging communication between the first device and the observer device.

16. The method of claim 1, further comprising:
refining the relational location computation based on a second observer device observing the wireless ranging communication between the first device and the second device.

17. An apparatus, comprising:
one or more network interfaces to communicate with a network;
a processor coupled to the one or more network interfaces and configured to execute one or more processes; and
a memory configured to store a process that is executable by the processor, the process comprising:
enabling, in response to a wireless ranging communication between a first device and a second device to determine a distance between the first device and the second device, a listening mode on an observer device in proximity to both the first device and the second device to observe the wireless ranging communication between the first device and the second device;
deducing, based on observation of the wireless ranging communication between the first device and the second device, a first complimentary measurement between the observer device and the first device, and a second complimentary measurement between the observer device and the second device; and
using the distance between the first device and the second device, the first complimentary measurement between the observer device and the first device, and the second complimentary measurement between the observer device and the second device for a relational location computation amongst the first device, the second device, and the observer device.

18. The apparatus of claim 17, wherein the first complimentary measurement comprises a first angle of arrival from the observer device to the first device, and the second complimentary measurement comprises a second angle of arrival from the observer device to the second device.

19. The apparatus of claim 17, wherein the process further comprises:
determining, based on the first complimentary measurement and the second complimentary measurement, a relative closeness of the observer device to the first device versus to the second device; and
generating, based on the relative closeness, a hyperbolic proximity estimation of the observer device in relation to the first device and the second device for use within the relational location computation.

20. A tangible, non-transitory, computer-readable medium storing program instructions that cause a device to execute a process comprising:
enabling, in response to a wireless ranging communication between a first device and a second device to determine a distance between the first device and the second device, a listening mode on an observer device in proximity to both the first device and the second device to observe the wireless ranging communication between the first device and the second device;
deducing, based on observation of the wireless ranging communication between the first device and the second device, a first complimentary measurement between the observer device and the first device, and a second complimentary measurement between the observer device and the second device; and
using the distance between the first device and the second device, the first complimentary measurement between the observer device and the first device, and the second complimentary measurement between the observer device and the second device for a relational location computation amongst the first device, the second device, and the observer device.
